(19) United States
(12) Patent Application Publication
(10) Pub. No.: US 2010/0303410 A1
(43) Pub. Date: Dec. 2, 2010

(54) ARRAYED WAVEGUIDE GRATING

(75) Inventors: Kazutaka Nara, Tokyo (JP); Noritaka Matsubara, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: FURUKAWA ELECTRIC CO., LTD., Tokyo (JP)

(21) Appl. No.: 12/787,096

(22) Filed: May 25, 2010

(30) Foreign Application Priority Data
May 26, 2009 (JP) 2009-126096

(51) Int. Cl. G02B 6/34

(52) U.S. Cl. 385/37

(57) ABSTRACT

An arrayed waveguide grating includes: at least one input waveguide; an input slab waveguide connected to the input waveguide; a plurality of output waveguides; an output slab waveguide connected to the output waveguides; and an arrayed waveguide. The arrayed waveguide includes: M channel waveguides connected between the input slab waveguide and the output slab waveguide; and a phase correcting portion configured to provide a predetermined phase to at least a part of the M channel waveguides by a form of the at least the part of the M channel waveguides being changed.

### CROSS-REFERENCE TO RELATED APPLICATIONS

This application is based upon and claims the benefit of priority from Japanese Patent Application No. 2009-126096, filed on May 26, 2009, the entire contents of which are incorporated herein by reference.

### BACKGROUND OF THE INVENTION

1. Field of the Invention

The present invention relates to an arrayed waveguide grating.

2. Description of the Related Art

Arrayed waveguide gratings (AWGs) may be roughly classified into two types. One type is Gaussian-type AWGs having transmission spectra of a Gaussian-function form, and flat-type AWGs having transmission spectra of a flat form. For flat-type AWGs, various characteristics are demanded, like high flatness of the transmission spectra, no being sloped, wavelength dispersion of nearly zero, and low side-to-side crosstalk.

However, when they are actually manufactured, errors in the manufacture lead to degradation in the characteristics. In AWGs, the length of each of channel waveguides of each arrayed waveguide basically increases by a constant pitch (an optical path length difference ΔL), but in practice, the optical path length difference ΔL between the manufactured channel waveguides slightly deviates from a design value, and this deviation from the design value leads to a phase error. The generation of a phase error in each channel waveguide of an arrayed waveguide is a cause of the degradation in the characteristics, such as crosstalk between channels.

As means for adjusting such degradation in the characteristics, a method of making a correction has been proposed, in which a phase error in each channel waveguide of an arrayed waveguide of a manufactured AWG is actually measured individually, a metal mask for correcting the phase error based on a result of the measurement is manufactured each time, and ultraviolet radiation is irradiated through the metal mask, to increase the refractive index of the channel waveguide according to the phase error (see Japanese Laid-open Patent Publication No. 2001-249243 and Japanese Laid-open Patent Publication No. 2003-240984, for example).

However, although the above conventional method achieves an ideal transmission spectrum form, it is necessary to manufacture the metal mask individually for each manufactured AWG chip, which makes mass production difficult.

### SUMMARY OF THE INVENTION

It is an object of the present invention to at least partially solve the problems in the conventional technology.

According to an aspect of the present invention, an arrayed waveguide grating includes: at least one input waveguide; an input slab waveguide connected to the input waveguide; a plurality of output waveguides; an output slab waveguide connected to the output waveguides; and an arrayed waveguide. The arrayed waveguide includes: M channel waveguides connected between the input slab waveguide and the output slab waveguide; and a phase correcting portion configured to provide a predetermined phase to at least a part of the M channel waveguides by a form of the at least the part of the M channel waveguides being changed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plane view of an arrayed waveguide grating according to a first embodiment of the present invention;

FIG. 2A is a schematic diagram of a structure of a phase correcting portion of the arrayed waveguide grating illustrated in FIG. 1 together with a phase distribution provided by the phase correcting portion, and FIG. 2B is an explanatory view of one channel waveguide of an arrayed waveguide in the phase correcting portion illustrated in FIG. 2A;

FIG. 3 is a plane view of a part of a photomask used in manufacturing the arrayed waveguide grating according to the first embodiment;

FIG. 4A is a schematic diagram of a phase correcting portion of an arrayed waveguide grating according to a second embodiment together with a phase distribution provided by the phase correcting portion, and FIG. 4B is an explanatory view of one channel waveguide of an arrayed waveguide in the phase correcting portion illustrated in FIG. 4A;

FIG. 5A is a graph indicating transmission spectra of 50 GHz-80 ch flat-type AWGs (i.e., three AWG chips, A, B and C) manufactured using a conventional photomask and a transmission spectrum of design values, and FIG. 5B is a graph representing the top portions of the transmission spectra illustrated in FIG. 5A;

FIG. 6A is a graph indicating transmission spectra of 50 GHz-80 ch flat-type AWGs (i.e., three AWG chips, A, B and C) manufactured using a conventional photomask and a transmission spectrum of design values, and FIG. 6B is a graph representing the top portions of the transmission spectra illustrated in FIG. 6A;

FIG. 7A is a graph indicating results of calculating 11 patterns of transmission spectra by providing a phase distribution of a(m−M/2)²+b(m−M/2)+c (where a=−0.5π to 0.5π, b=c=0) to the m^{th} channel waveguide of an arrayed waveguide, and FIG. 7B is a graph representing the top portions of spectra illustrated in FIG. 7A;

FIG. 8A is a graph indicating results of calculating 11 patterns of transmission spectra by providing a phase distribution of a(m−M/2)³+b(m−M/2)²+c(m−M/2)+d (where a=−0.5π to 0.5π, b=c=d=0) to the m^{th} channel waveguide of the arrayed waveguide, and FIG. 8B is a graph representing the top portions of spectra illustrated in FIG. 8A;

FIG. 9A is a graph indicating transmission spectra of the arrayed waveguide grating according to the first embodiment, and FIG. 9B is a graph representing the top portions of the transmission spectra illustrated in FIG. 9A; and

FIG. 10A is a graph indicating transmission spectra of the arrayed waveguide grating according to the second embodiment, and FIG. 10B is a graph representing the top portions of the transmission spectra illustrated in FIG. 10A.

### DETAILED DESCRIPTION OF THE PREFERRED EMBODIMENTS

Embodiments according to the present invention will be explained below with reference to the accompanying drawings. In explaining each embodiment, the same parts are referred to by the same reference numerals and redundant explanation will be omitted.

The inventors manufactured arrayed waveguide gratings, analyzed transmission spectrum characteristics of the manufactured arrayed waveguide gratings in detail, and found that in most cases it was possible to explain a phase error generated in an arrayed waveguide with a quadratic-function phase distribution or a cubic-function phase distribution and that the phase error was caused by the photomask. The inventors also found that by introducing a phase correcting portion limited to a quadratic-function phase error or a cubic-function phase error to an arrayed waveguide of an arrayed waveguide grating, using a phase corrector provided in a photomask beforehand, characteristics that cause no problem for practical use were obtained.

The present invention has been made in view of the above findings, and the substance of the present invention is to manufacture an AWG by introducing beforehand a quadratic-function phase distribution or a cubic-function phase distribution as a waveguide parameter of the arrayed waveguide.

### First Embodiment

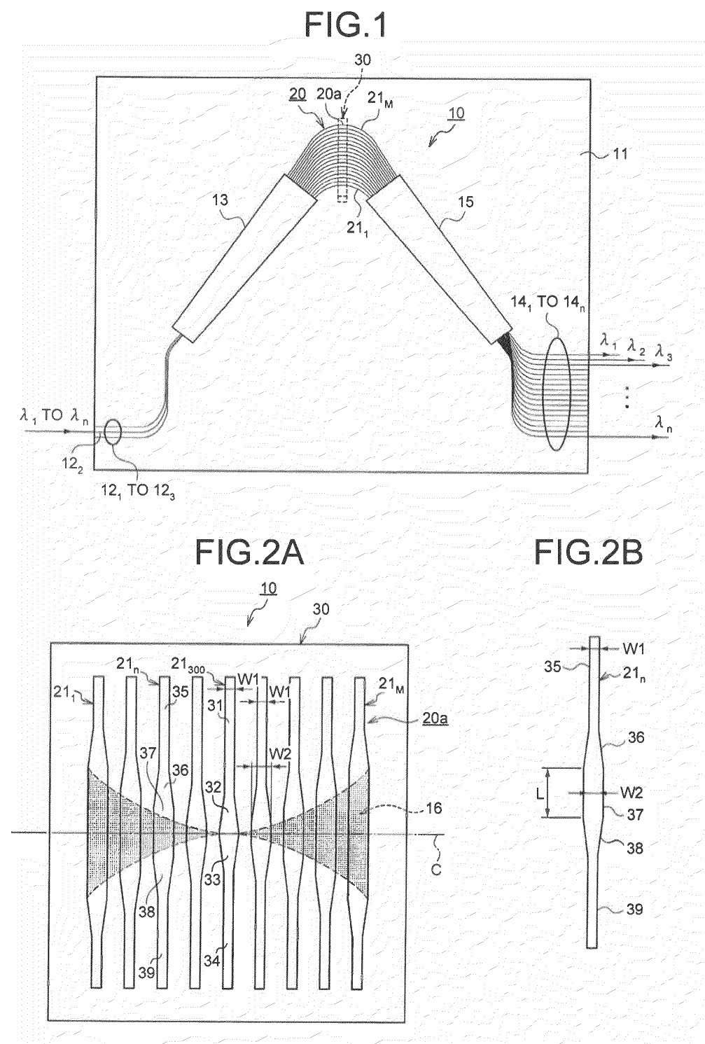

An arrayed waveguide grating (hereinafter, “AWG”) 10 is a planar light wave circuit (PLC) in which an optical waveguide including a core and a cladding is formed on a quartz substrate 11 with a quarts PLC manufacturing technology using a semiconductor microprocessing technology, such as photolithography, as illustrated in FIG. 1.

The AWG 10 includes three input waveguides 12₁ to 12₃, an input slab waveguide 13 connected to the input waveguides 12₁ to 12₃, a plurality of (n) output waveguides 14₁ to 14ₙ, an output slab waveguide 15 connected to the output waveguides 14₁ to 14ₙ, and an arrayed waveguide 20 including M channel waveguides 21₁ to 21_{M} connected between the input slab waveguide 13 and the output slab waveguide 15. The number of input waveguides of the AWG 10 is not limited to three as long as there is at least one of them. A silicon substrate may be used instead of the quartz substrate 11.

The channel waveguides of the arrayed waveguide 20 are counted from the inner channel waveguide sequentially, like the first, the second, . . . , the m^{th}, and the M^{th}. Specifically, the channel waveguide 21₁ is the first channel waveguide and the channel waveguide 21_{M} is the M^{th} channel waveguide. In the first embodiment, as an example, the number M of channel waveguides of the arrayed waveguide 20 is 600 (M=600). FIG. 1 illustrates the channel waveguides in the arrayed waveguide 20 with a smaller number for simplification.

In the AWG 10, the length of each of the channel waveguides 21₁ to 21_{M} in the arrayed waveguide 20 increases by a constant pitch (an optical path length difference ΔL).

Specifically, if the length of the innermost channel waveguide 21₁ of the M channel waveguides 21₁ to 21_{M} is L₀, the length of the m^{th} channel waveguide 21ₘ is L+(m−1)ΔL.

The AWG 10 according to the first embodiment having the above-described configuration is the same as a conventional AWG in which the arrayed waveguide includes M channel waveguides, the widths of the channel waveguides are equal, and the length of each of the channel waveguides increases by a constant optical path length difference ΔL, except for the following. In the conventional AWG, widths of the channel waveguides in the arrayed waveguide are all equal (hereinafter, “basic waveguide width W1”). To manufacture such conventional AWGs by using, for example, photolithography, a photomask is used that includes a waveguide pattern for forming a plurality of channel waveguides having the basic waveguide width W1 in an array waveguide forming area that is a part of a waveguide forming area. Such a photomask having a waveguide pattern for forming all of the channel waveguides of the arrayed waveguide with the same basic waveguide width W1 is hereinafter referred to as a “conventional photomask”.

The AWG 10 according to the first embodiment illustrated in FIG. 1 is characterized in that the arrayed waveguide 20 is provided with a phase correcting portion 30 that provides a predetermined phase to at least a part of the M channel waveguides 21₁ to 21_{M} by changing the shape of at least a part of the channel waveguides.

In the first embodiment, the phase correcting portion 30 is formed to provide a phase of a(m−M/2)²+b(m−M/2)+c to the m^{th} (1≦m≦M) channel waveguide of the M channel waveguides 21₁ to 21_{M}, where a, b and c are each a constant of a value within a range of −2π to 2π (radians).

As illustrated in FIGS. 1 and 2A, the phase correcting portion 30 is provided in a linear waveguide portion 20a of the arrayed waveguide 20. FIG. 2A represents an enlarged view of the structure of the phase correcting portion 30 illustrated in FIG. 1 and schematically illustrates the phase distribution that the phase correcting portion 30 provides to each of the channel waveguides 21₁ to 21_{M} of the arrayed waveguide 20. FIG. 2A also illustrates the channel waveguides 21₁ to 21_{M} of the arrayed waveguide 20 with a number smaller than the actual number M for simplification.

To provide a phase of a(m−M/2)²+b(m−M/2)+c to the m^{th} channel waveguide of the M channel waveguides 21₁ to 21_{M}, the phase correcting portion 30 is configured such that the phase correcting portion 30 includes a wide waveguide having a width W2 larger than the basic waveguide width W1 in each of a part or all of the M channel waveguides and that a length of the wide waveguide is different for each channel waveguide.

Specifically, as illustrated in FIG. 2A, in the phase correcting portion 30, the 300^{th} (m=300) channel waveguide 21₃₀₀ has a configuration in which a linear waveguide 31 having the basic waveguide width W1, a tapered waveguide 32, a tapered waveguide 33, and a linear waveguide 34 having the basic waveguide width W1 are connected one after another. In other words, the channel waveguide 21₃₀₀ is not provided with a wide waveguide having a width W2 larger than the basic waveguide width W1.

In the phase correcting portion 30, as illustrated in FIGS. 2A and 2B, each channel waveguide 21ₙ other than the channel waveguide 21₃₀₀ (1≦n≦M, n≠300) of the M channel waveguides 21₁ to 21_{M} has a configuration in which a linear waveguide 35 having the basic waveguide width W1, a tapered waveguide 36, a wide waveguide 37 having the width W2, a tapered waveguide 38, and a linear waveguide 39 having the basic waveguide width W1 are connected one after another.

In the phase correcting portion 30, the length L of the wide waveguide 37 of each channel waveguide 21ₙ is different for each channel waveguide. In the first embodiment, to provide a phase of a(m−M/2)²+b(m−M/2)+c to the m^{th} channel waveguide, the length L is set as follows.

The length L of the wide waveguide 37 of the first channel waveguide 21₁ and the length L of the wide waveguide 37 of the M^{th} (600^{th}) channel waveguide 21_{M} are the longest and the length L becomes gradually shorter from the first channel waveguide 21₁ toward the channel waveguide 21₂₉₉ and becomes shorter gradually from the channel waveguide 21_{M} toward the channel waveguide 21₃₀₁.

In the phase correcting portion 30, the shapes of the tapered waveguides 32, 33, 36 and 38 are uniform. Because a pair of tapered waveguides shaped identically is provided in each of the M channel waveguides 21₁ to 21_{M}, no phase error is generated among the channel waveguides 21₁ to 21_{M}.

A phase φ that the phase correcting portion 30 provides to each of the channel waveguides 21₁ to 21_{M} is represented by the following equation.

φ=(2π/λ)(n_{corr}−n_{org})·L

In this equation, n_{org} is the refractive index of a linear waveguide having the basic waveguide width W1 in each channel waveguide, n_{corr} is the refractive index of a wide waveguide in each channel waveguide, and L is the length of a wide waveguide in each channel waveguide

In the phase correcting portion 30, the linear waveguide portion 20a of the arrayed waveguide 20, i.e., the linear waveguide of each of the channel waveguides 21₁ to 21_{M} (excluding the channel waveguide 21₃₀₀) is provided with the wide waveguide 37 having the width W2 to increase the effective refractive index of each channel waveguide and to provide a phase larger than a phase of design values to each channel waveguide. In addition, in the phase correcting portion 30, by setting the length L of the wide waveguide 37 of each of the channel waveguides 21₁ to 21_{M} (excluding the channel waveguide 21₃₀₀) as described above, the magnitudes of phases to be provided to the channel waveguides 21₁ to 21_{M} (excluding the channel waveguides 21₃₀₀) are made different.

By providing the phase correcting portion 30 configured as above in the linear waveguide portion of the arrayed waveguide 20, it is possible to provide a phase of a(m−M/2)²+b (m−M/2)+c to the m^{th} channel waveguide of the channel waveguides 21₁ to 21_{M}.

Reference numeral 16 in FIG. 2A schematically represents a phase distribution of a quadratic-function that the phase correcting portion 30 provides to the arrayed waveguide 20. In the phase distribution 16, an up-and-down direction in FIG. 2A represents the magnitude of the phase in FIG. 2A.

In the first embodiment, the center of the wide waveguide 37 of each of the channel waveguides 21₁ to 21_{M} (excluding the channel waveguide 21₃₀₀) and a connection point between the tapered waveguide 32 and the tapered waveguide 33 of the channel waveguide 21₃₀₀ each coincide with the center C of the arrayed waveguide 20. Therefore, the phase correcting portion 30 provides a phase to each of the channel waveguides 21₁ to 21_{M} symmetrically about the center of the AWG 10, i.e., the center C of the arrayed waveguide 20.

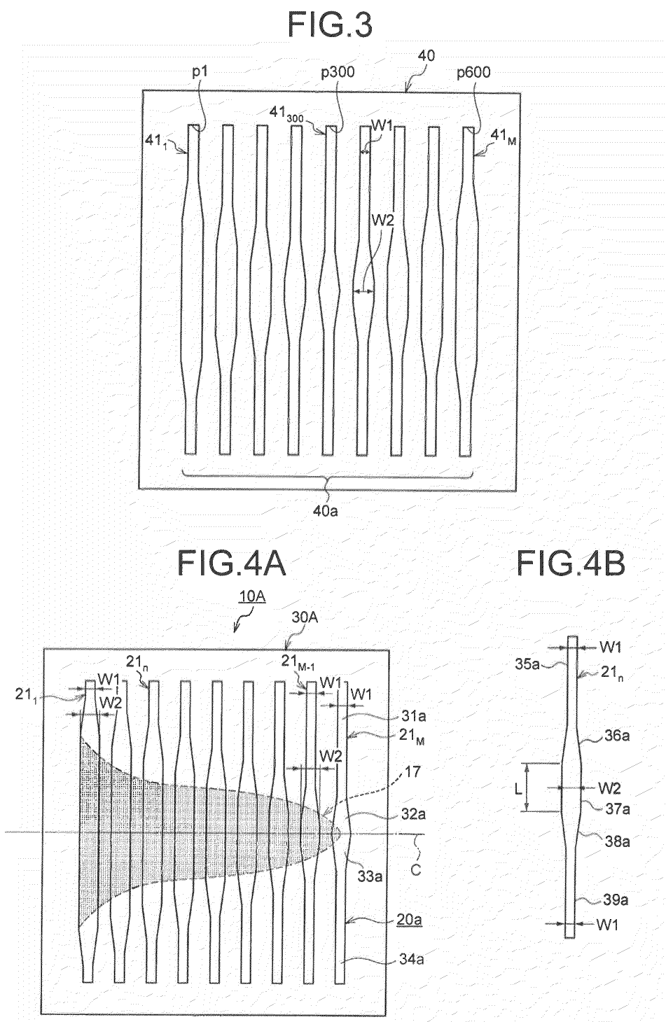

When the AWG 10 provided with the phase correcting portion 30 in the linear waveguide portion of the arrayed waveguide 20 is manufactured using photolithography, a photomask 40 as illustrated in FIG. 3 is used, which is structured differently from the above conventional photomask. FIG. 3 illustrates only the phase corrector of the waveguide pattern formed on the photomask 40 for forming each waveguide of the AWG 10. This phase corrector is for forming the phase correcting portion 30 in the arrayed waveguide forming area for forming each channel waveguide of the arrayed waveguide 20.

The photomask 40 includes a phase corrector 40a illustrated in FIG. 3. Waveguide patterns 41₁ to 41_{M} as illustrated in FIG. 3 are formed in the phase corrector 40a. These waveguide patterns 41₁ to 41_{M} are for respectively forming the M channel waveguides 21₁ to 21_{M} of the phase correcting portion 30 illustrated in FIG. 2A. Hereinafter, the photomask 40 is referred to as “photomask of the present invention”.

In the AWG 10 according to the first embodiment configured as above, when multiplexed lights of a plurality of lights having different wavelengths (λ₁ to λₙ) are input through one of the input waveguides 12₁ to 12₃, for example, through the input waveguide 12₂, the lights (of wavelengths λ₁ to λₙ) diverge in the first slab waveguide 13 by diffraction and then are input to the arrayed waveguide 20. The arrayed waveguide 20 includes the M channel waveguides 21₁ to 21_{M} and adjacent channel waveguides are arrayed with the constant optical path length difference ΔL between them. Therefore, at an output end of the arrayed waveguide 20, the lights that have passed through the respective channel waveguides 21₁ to 21_{M} have a phase difference. The lights that have passed through the arrayed waveguide 20 then propagate to the output slab waveguide 15 and diverge by diffraction, but the lights that have passed through the respective channel waveguides 21₁ to 21_{M} interfere with each other. Accordingly these lights intensify each other only in a direction in which their wave fronts match each other and are condensed.

The condensing direction differs depending on the wavelength. Therefore, by arranging the output waveguides 14₁ to 14ₙ at respective condensing positions that differ according to the wavelengths in an output portion of the output slab waveguide 15, it is possible to output lights of different wavelengths λ₁ to λₙ from the respective output waveguides 14₁ to 14ₙ. In this case, the AWG 10 functions as a demultiplexer. In the case where the AWG is used as a multiplexer, when lights of wavelengths λ₁ to λₙ are input through the respective output waveguides 14₁ to 14ₙ, multiplexed lights of different wavelengths (λ₁ to λₙ) are output from one of the input waveguides 12₁ to 12₃, for example, the input waveguide 12₂.

### Second Embodiment

An arrayed waveguide grating (AWG) 10A according to a second embodiment of the present invention will be explained below with reference to FIGS. 4A and 4B.

In the AWG 10A according to the second embodiment, a phase correcting portion 30A is formed such that a phase of a(m−M/2)³+b(m−M/2)²+c(m−M/2)+d is provided to the m^{th} (1≦m≦M) channel waveguide of the M channel waveguides 21₁ to 21_{M}, where a, b and c are each a constant of a value within a range of −2π to 2π (radians). The configuration of the AWG 10A except for the phase correcting portion 30A is similar to that of the AWG 10 according to the first embodiment.

As illustrated in FIG. 4A, the phase correcting portion 30A is provided in the linear waveguide portion 20a (see FIG. 1) in the arrayed waveguide 20 like the phase correcting portion 30 according to the first embodiment. Similarly to FIG. 2A, FIG. 4A represents an enlarged view of a structure of the phase correcting portion 30 and schematically illustrates the phase distribution that the phase correcting portion 30A provides to each of the channel waveguides 21₁ to 21_{M} in the arrayed waveguide 20. FIG. 4A also represents the channel waveguides 21₁ to 21_{M} in the arrayed waveguide 20 with a number smaller than the actual number M (M=600) for simplification.

To provide a phase of a(m−M/2)³+b (m−M/2)²+c(m−M/2)+d to the m^{th} channel waveguide of the M channel waveguides 21₁ to 21_{M}, the phase correcting portion 30A has a configuration in which the phase correcting portion 30A includes a wide waveguide having a width W2 larger than a basic waveguide width W1 in each of a part or all of the M channel waveguides and the length of the wide waveguide is different for each channel waveguide.

Specifically, as illustrated in FIG. 4A, in the phase correcting portion 30A, the 600^{th} (M=600) channel waveguide 21_{M} has a configuration in which a linear waveguide 31a having the basic waveguide width W1, a tapered waveguide 32a, a tapered waveguide 33a, and a linear waveguide 34a having the basic waveguide width W1 are connected one after another. In other words, the channel waveguide 21_{M} is not provided with the wide waveguide having the width W2 larger than the basic waveguide width W1.

In the phase correcting portion 30A, each channel waveguide 21ₙ other than the channel waveguide 21_{M} (1≦n≦M−1) of the M channel waveguides 21₁ to 21_{M} has a configuration, as illustrated in FIG. 4B, in which a linear waveguide 35a having the basic waveguide width W1, a tapered waveguide 36a, a wide waveguide 37a having the width W2, a tapered waveguide 38a, and a linear waveguide 39a having the basic waveguide width W1 are connected one after another.

In the phase correcting portion 30A, the length L of the wide waveguide 37a of each channel waveguide 21ₙ is different for each channel waveguide. In the first embodiment, to provide a phase of a(m−M/2)³+b(m−M/2)²+c(m−M/2)+d to the m^{th} channel waveguide, the length L is set as follows.

The length L of the wide waveguide 37a of the first channel waveguide 21₁ is the longest and the length becomes gradually shorter from the first channel waveguide 21₁ to the channel waveguide 21_{M-1}.

In the phase correcting portion 30A, the shapes of the tapered waveguides 32a, 33a, 36a and 38a are uniform.

By providing the phase correcting portion 30A configured as above in the linear waveguide portion 20a of the arrayed waveguide 20, it is possible to provide a phase of a(m−M/2)³+b(m−M/2)²+c(m−M/2)+d to the m^{th} channel waveguide of the channel waveguides 21₁ to 21_{M}.

In FIG. 4A, the portion denoted by reference numeral 17 schematically represents a cubic-function phase distribution that the phase correcting portion 30A provides to the arrayed waveguide 20.

In the second embodiment, the center of the wide waveguide 37a of each of the channel waveguides 21₁ to 21_{M-1} and a connection point between the tapered waveguide 32a and the tapered waveguide 33a of the channel waveguide 21_{M} each coincide with the center C of the arrayed waveguide 20. Therefore, the phase correcting portion 30A provides a phase to the channel waveguides 21₁ to 21_{M} symmetrically about the center of the AWG 10A, i.e., the center C of the arrayed waveguide 20.

When the AWG 10A in which the phase correcting portion 30A is provided in the linear waveguide portion 20a of the arrayed waveguide 20 is manufactured using photolithography, the photomask 40 of the present invention (not illustrated) is used, which includes a phase corrector similar to that of the phase corrector 40a of the photomask of the present invention 40 illustrated in FIG. 3. A waveguide pattern for forming the M channel waveguides 21₁ to 21_{M} in the phase correcting portion 30A illustrated in FIG. 4A is formed in the phase corrector of this photomask.

Method of Manufacturing AWG 10

A method of manufacturing the AWG 10 or the AWG 10A having the above configurations will be explained below.

(1) First, “conventional AWGs” are manufactured by, for example, photolithography by using the “conventional photomask”.

In other words, the conventional AWGs each including an arrayed waveguide formed of M channel waveguides of equal widths are manufactured.

For example, 50 GHz-80 ch flat-type AWGs are manufactured.

(2) Subsequently, the transmission spectra of the conventional AWGs that are manufactured at step (1) are measured to obtain their actual values.

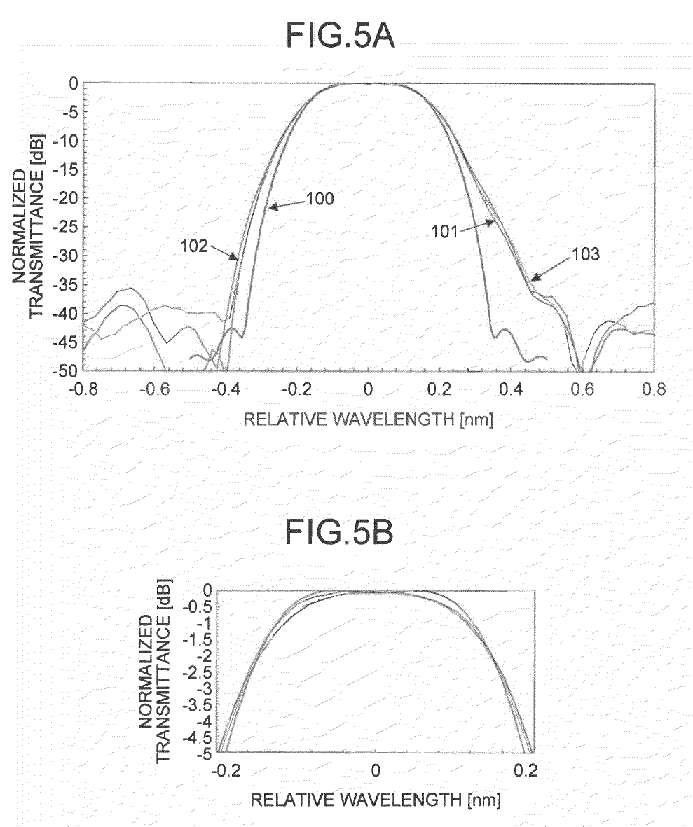

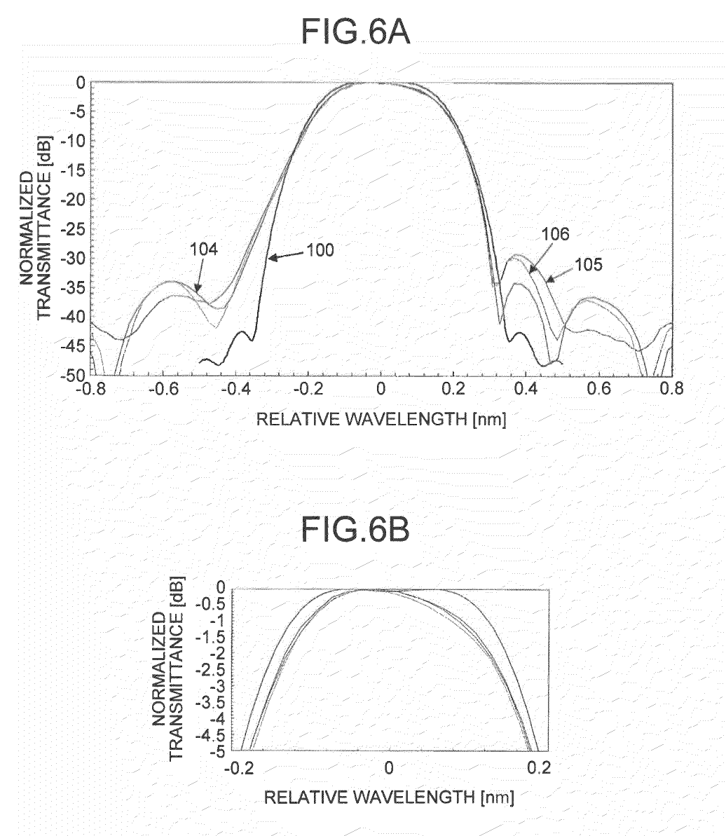

FIGS. 5A and 5B and FIGS. 6A and 6B represent the results of manufacturing the 50 GHz-80 ch flat-type AWGs. In FIG. 5A, a curve 100 denotes a transmission spectrum of design values of the flat-type AWGs, and curves 101, 102, and 103 denote actual values in transmission spectra of the manufactured conventional AWGs (AWG chips) A, B, and C. In FIG. 6A, the curve 100 denotes the transmission spectrum of the design values of the flat-type AWGs and curves 104, 105, and 106 denote measured transmission spectra of the manufactured conventional AWGs A, B, and C.

From FIG. 5A, it is understood that the shapes of the transmission spectra of the AWG chips A, B, and C approximately coincide with each other. Further, from FIG. 6A, it is understood that the shapes of the transmission spectra of the AWG chips A, B, and C approximately coincide with each other. From these, it is understood that the AWG chips A, B, and C, which have transmission spectrum shapes that approximately match each other are manufactured.

Furthermore, it is understood, by carefully observing FIG. 5A, that the spectra of the AWG chips A, B, and C, which are represented by the curves 101, 102, and 103, are more spread than the transmission spectrum of the design-values, and that the top of each of the spectra is rounded (see FIG. 5B). In contrast, from FIG. 6A, it is understood that the top portion of each of the transmission spectra of the AWG chips A, B, and C, which are represented by the curved lines 104, 105, and 106, is sloped (see FIG. 6B).

The inventors manufactured various AWGs, and found that in many cases, the manufactured AWGs corresponded to FIG. 5A or FIG. 6A.

In all of the cases represented in FIGS. 5A and 6A, phase variation occurs in the arrayed waveguides, and their characteristics are degraded. In other words, in the AWG chips A, B, and C represented by the curves 101, 102, and 103 in FIG. 5A, manufacturing errors in the photomask itself result in phase errors in the arrayed waveguides and degradation in their characteristics. Similarly, in the AWG chips A, B, and C represented by the curves 104, 105, and 106 in FIG. 6A, manufacturing errors in the photomask itself result in phase errors in the arrayed waveguides and degradation in their characteristics.

(3) Phase error distributions that occur in the arrayed waveguides 20 due to manufacturing errors in the photomask itself is calculated based on the degradation in the transmission spectrum characteristics of the conventional AWGs (the degradation in the characteristics illustrated in FIGS. 5A and 6A), which is obtained at step (2).

For example, fitting with the actual values is performed, limiting to a quadratic-function phase error or a cubic-function phase error, to obtain the phase error distributions that occur in the arrayed waveguides 20.

Specifically, a phase of a(m−M/2)²+b(m−M/2)+c is provided to the m^{th} channel waveguide, transmittance is calculated, and a phase error distribution of a quadratic-function that fits the transmission spectrum of the design values is obtained. Alternatively, a phase of a(m−M/2)³+b(m−M/2)²+c(m−M/2)+d is provided to the m^{th} channel waveguide, transmittance is calculated, and a phase error distribution of a cubic-function that fits the transmission spectrum of the design values is obtained. The “phase error distribution” used herein is a distribution of phase errors that occur in each channel waveguide of the arrayed waveguides.

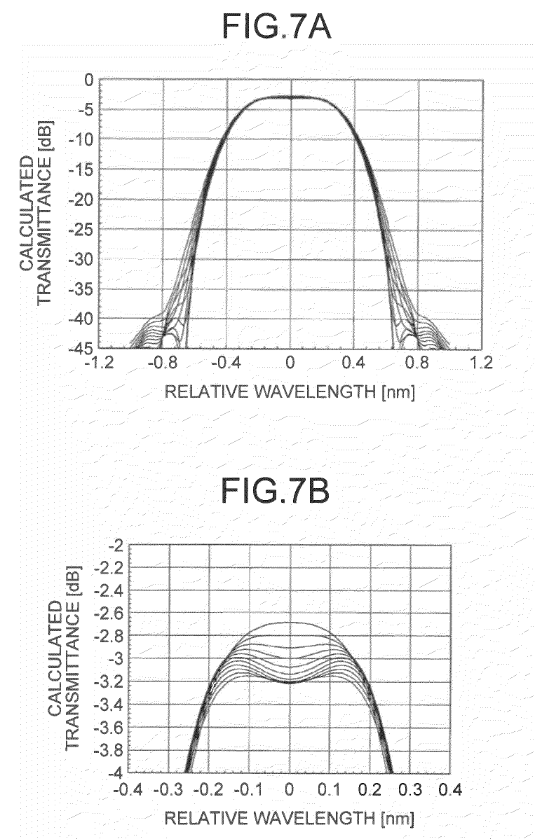

It was found, as illustrated in FIGS. 7A and 7B, that when the phase distribution of the quadratic-function was provided to the AWG, the transmission spectra were spread and the top portions of the spectra were rounded. FIG. 7A represents calculated values of 11 patterns of transmission spectra that are obtained when b=c=0 and the value of “a” is changed within the range of −0.5 π to 0.5 π by 0.1π.

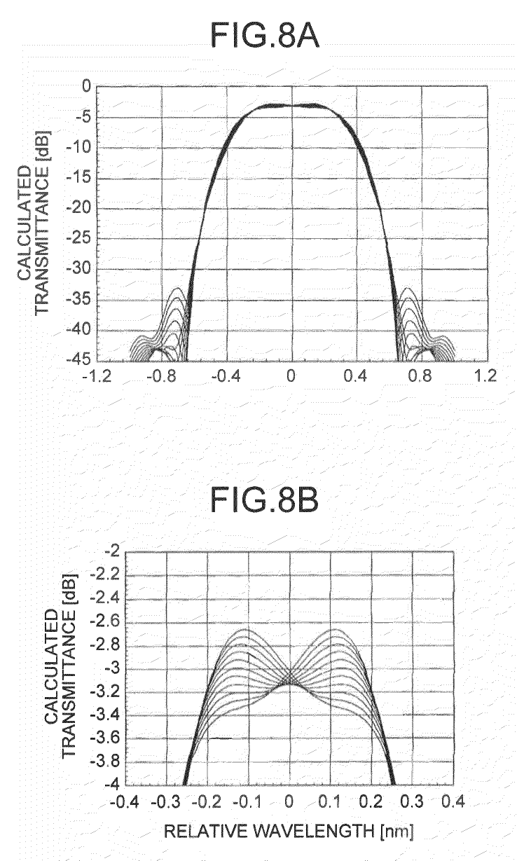

As illustrated in FIGS. 8A and 8B, it was found that when the phase distribution of the cubic-function phase distribution was provided to the AWG, the top portions of the spectra were sloped. FIG. 8A represents calculated values of 11 patterns of transmission spectra that are obtained when b=c=d=0 and the value of “a” is varied within the range of −0.5 π to 0.5 π by 0.1π.

At step (3), when the transmission spectrum characteristics (actual values) illustrated in FIG. 5A are obtained, the phase error distribution of the quadratic-function is provided to the design values to calculate a transmission spectrum. When the transmission spectrum characteristics (actual values) depicted in FIG. 6A are obtained, the phase error distribution of the cubic-function is provided to the design values to calculate a transmission spectrum. Thereafter, a phase error distribution is extracted for which the calculated transmission spectrum fits, by the least squares method, the transmission spectrum of the design values, which is represented by the curve 100 in FIG. 5A or FIG. 6A.

As described above, at step (3), calculation is performed premised on the phase correcting portion that provides to the arrayed waveguide 20 the phase error of the quadratic-function or the cubic-function as input information, to find the form closest to the actual values.

For example, if there is degradation in the characteristics as illustrated in FIGS. 5A and 5B, variation in the phase is occurring in each arrayed waveguide 20. In this case, at step (3), by reverse computation by inserting the phase distribution of the quadratic-function phase distribution to the design values of the conventional AWGs, for which the characteristics illustrated in FIG. 5A were obtained, the transmission spectrum characteristics that are approximately close to the design values are obtained.

Conversely, because phase distributions are generated in the actually manufactured conventional AWGs with degradation in their characteristics as illustrated in FIG. 5A, by incorporating these phase distributions from the design stage, the finally manufactured AWGs 10 will have transmission spectrum characteristics approximately close to the design values.

In contrast, if there is degradation in the characteristics as illustrated in FIGS. 6A and 6B, phase variations are occurring in the arrayed waveguides 20. In this case, at step (3), by reverse computation inserting the phase distribution of the cubic-function to the design values of the conventional AWGs, for which the characteristics illustrated in FIG. 6A were obtained, the transmission spectrum characteristics that are approximately close to the design values are obtained.

Conversely, because phase distributions are generated in the actually manufactured AWGs illustrated in FIG. 6A, by incorporating the phase distributions from the design stage, the finally manufactured AWGs 10 will have transmission spectrum characteristics approximately close to the design values.

(4) A form of the phase correcting portion (the phase correcting portion 30 in FIG. 2A or the phase correcting portion 30A in FIG. 4A), which will provide to each channel waveguide in the arrayed waveguides a phase for compensating (eliminating) the phase error distributions calculated at step (3), is determined.

At this step, for example, the width W2 and the length L of the wide waveguide 37 in each of the channel waveguides 21₁ to 21_{M} are determined.

(5) A photomask is then manufactured, which has an arrayed waveguide forming area for forming an arrayed waveguide, to which a phase correcting portion of the form determined at step (4) is introduced.

In the first embodiment, the photomask of the present invention 40 as illustrated in FIG. 3 is manufactured. In the second embodiment, the photomask of the present invention of which illustration is omitted is manufactured.

As described above, the waveguide parameters that compensate phase errors generated in the photomask are incorporated in the photomask of the present invention in advance.

### First Example

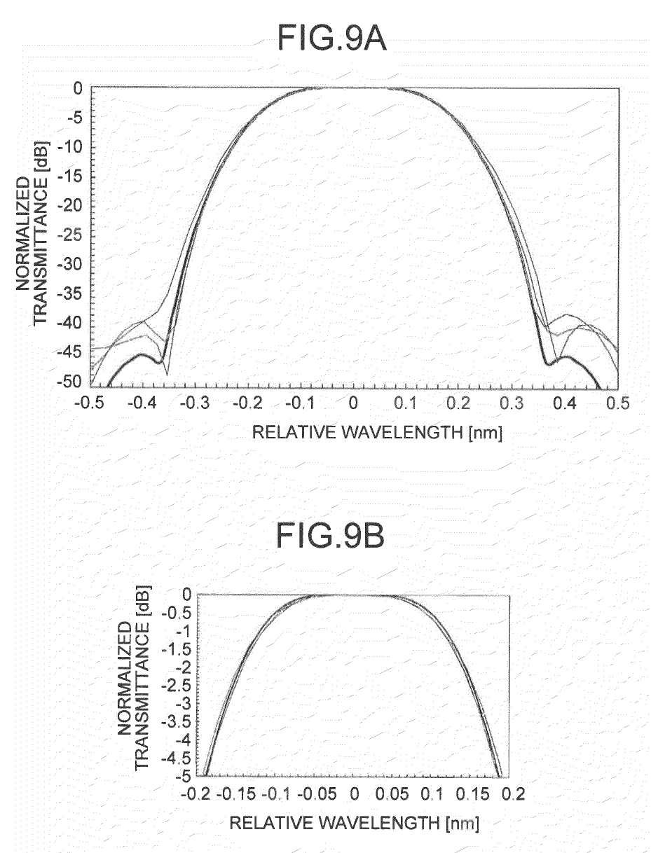

The 50 GHz-80 ch flat-type AWGs 10 (see FIG. 1) including the phase correcting portion 30 as illustrated in FIG. 2A were manufactured by a normal quartz PLC technology. Specifically, in the photomask 40 of the present invention illustrated in FIG. 3, the wide waveguides 37 each having the width W2 were formed and the length L of each of the wide waveguides 37 was set to a predetermined value, such that a phase of 0.7π(m−M/2)² was provided to the m^{th} channel waveguide of the channel waveguides 21₁ to 21_{M}. The transmission spectrum characteristics of the manufactured AWGs 10 are depicted in FIGS. 9A and 9B. It is understood from FIGS. 9A and 9B that transmission spectra approximate to the design values are obtained in the manufactured AWGs 10 and the method according to the present invention is very effective.

### Second Example

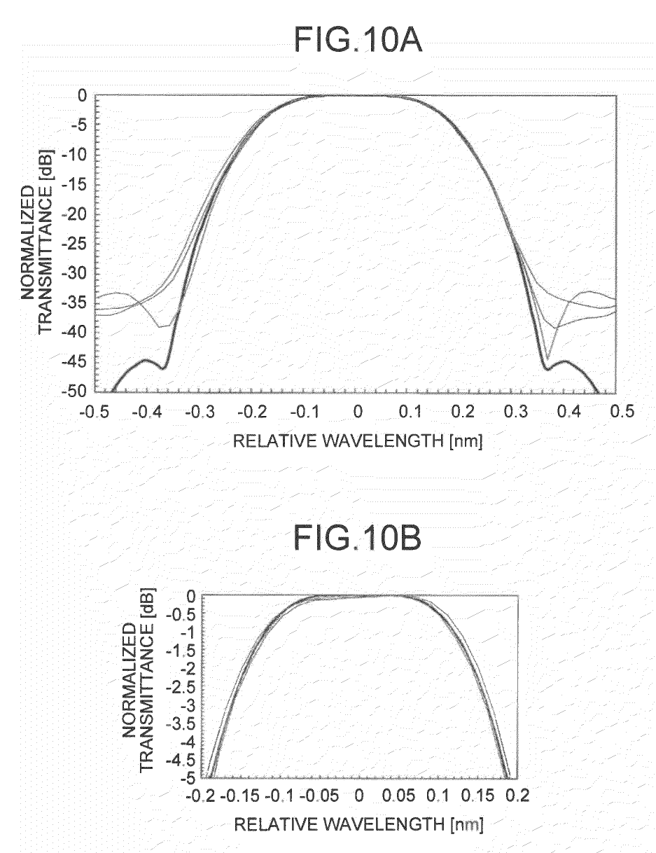

Using the normal quartz PLC technology, 50 GHz-80 ch flat-type AWGs 10A each including the phase correcting portion 30A as illustrated in FIG. 4A were manufactured. Specifically, in the above-described photomask of the present invention, the wide waveguides 37a (see FIG. 4B) each having the width W2 were formed in the photomask of the present invention and the length L of each of the wide waveguides 37a was set to a predetermined value, such that a phase of 0.3π(m−M/2)³ was provided to the m^{th} (1≦m≦M) channel waveguide of the M channel waveguides 21₁ to 21_{M}. The transmission spectrum characteristics of the manufactured AWGs 10A are illustrated in FIGS. 10A and 10B. It is understood from FIGS. 10A and 10B that transmission spectra approximate to the design values are obtained in the manufactured AWGs 10A and the method according to the present invention is very effective.

The first embodiment works and provides effects as described below.

(1) The phase correcting portion 30 provides a phase of a(m−M/2)² b(m−M/2)+c to the m^{th} channel waveguide, so that the phase in each of the channel waveguides 21₁ to 21_{M} of the arrayed waveguide 20 is changed to cancel the phase errors in the arrayed waveguide 20 and a transmission spectrum close to the design values is obtained. In other words, by incorporating in advance the form that compensates the phase error generated in the conventional photomask in the phase corrector provided in the photomask of the present invention 40 and manufacturing an AWG using the photomask 40, it is possible to obtain transmission spectrum characteristics close to the design characteristics and realize the AWG 10 suitable for mass production.

(2) Because the phase correcting portion 30 illustrated in FIG. 2A is provided in the linear waveguide portion 20a of the arrayed waveguide 20, designing of the photomask 40 having the waveguide pattern for forming the phase correcting portion 30 and designing of the AWG 10 itself become easy.

(3) Because the phase correcting portion 30 provides a phase to each of the channel waveguides 21₁ to 21_{M} symmetrically about the center C of the arrayed waveguide 20, it is possible to change the phase in each of the channel waveguides 21₁ to 21_{M} symmetrically equally about the center C of the arrayed waveguide 20 and to obtain a transmission spectrum close to the design values.

(4) Because the phase correcting portion 30 is provided only in a narrow partial area of the arrayed waveguide 20, i.e., in the linear waveguide portion 20a, it is possible to ignore the influence of the manufacturing errors in the photomask 40 on the phase correcting portion 30 and to obtain a transmission spectrum close to the design values.

The second embodiment works and provides effects described below.

(1) The phase correcting portion 30A provides a phase of a(m−M/2)³+b(m−M/2)²+c(m−M/2)+d to the m^{th} channel waveguide, so that the phase in each of the channel waveguides 21₁ to 21_{M} in the arrayed waveguide 20 is changed to cancel the phase errors in the arrayed waveguide 20 and a transmission spectrum close to the design values is obtained. In other words, by incorporating in advance the form that compensates the phase errors generated in the conventional photomask into the phase corrector provided in the photomask of the present invention and manufacturing an AWG using the photomask, it is possible to obtain transmission spectrum characteristics close to the design characteristics and to realize the AWG 10A suitable for mass production.

(2) Because the phase correcting portion 30A illustrated in FIG. 4A is provided in the linear waveguide portion 20a of the arrayed waveguide 20, designing of the photomask having the waveguide pattern for forming the phase correcting portion 30A and designing of the AWG 10A itself become easy.

(3) Because the phase correcting portion 30A provides a phase to each of the channel waveguides 21₁ to 21_{M} symmetrically about the center C of the arrayed waveguide 20, it is possible to change the phase in each of the channel waveguides 21₁ to 21_{M} symmetrically equally about the center C of the arrayed waveguide 20 and to obtain a transmission spectrum close to the design values.

(4) Because the phase correcting portion 30A is provided only in a narrow partial area of the arrayed waveguide 20, i.e., in the linear waveguide portion 20a, it is possible to ignore the influence of the manufacturing errors in the photomask itself on the phase correcting portion 30 and to obtain a transmission spectrum close to the design values.

The present invention may be modified and embodied as described below.

In each of the embodiments, examples in which 50 GHz-80 ch flat-type AWGs are manufactured were explained, but the present invention is also applicable to a flat-type AWG with a different frequency interval and a different number of channels. For example, the present invention is applicable to 100 GHz-40 ch flat-type AWGs.

The present invention is not limited to flat-type AWGs and is applicable to Gaussian-type AWGs having transmission spectra of Gaussian function forms. Specifically, similarly to the first embodiment, the phase correcting portion is formed such that a phase of a(m−M/2)²+b(m−M/2)+c is applied to the m^{th} (1≦m≦M) channel waveguide of the M channel waveguides 21₁ to 21_{M}.

In each of the embodiments, the phase correcting portion has a configuration in which the phase correcting portion includes the wide waveguide having the width W2 larger than the basic waveguide width W1 in each of a part or all of the M channel waveguides and the length of the wide waveguide is different for each channel waveguide. However, the present invention is not limited to this. The present invention is applicable to an AWG including a phase correcting portion having a configuration in which only the length of each channel waveguide is changed in a part or all of the M channel waveguides.

There are two methods for changing only the length of each channel waveguide.

(1) Only the lengths of the M channel waveguides 21₁ to 21_{M} are changed such that a phase of a(m−M/2)²+c(m−M/2) is provided to the m^{th} channel waveguide 21ₘ. In this case, the length of the m^{th} channel waveguide 21ₘ is represented by the following equation.

L₀+(m−1)ΔL+[a(m−M/2)²+c(m−M/2)]

In this equation, L₀ is the length of the innermost channel waveguide 21₁ of the M channel waveguides 21₁ to 21_{M}.

(2) Only the lengths of the M channel waveguides 21₁ to 21_{M} are changed such that a phase of a(m−M/2)³+b(m−M/2)²+c(m−M/2)+d is provided to the m^{th} channel waveguide 21ₘ. In this case, the length of the m^{th} channel waveguide 21ₘ is represented by the following equation.

L₀+(m−1)ΔL+[a(m−M/2)³+b(m−M/2)²+c(m−M/2)+d]

According to an embodiment of the present invention, it is possible to obtain a transmission spectrum close to design values and to realize an arrayed waveguide grating suitable for mass production.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An arrayed waveguide grating, comprising:
at least one input waveguide;
an input slab waveguide connected to the input waveguide;
a plurality of output waveguides;
an output slab waveguide connected to the output waveguides; and
an arrayed waveguide including:
M channel waveguides connected between the input slab waveguide and the output slab waveguide; and
a phase correcting portion configured to provide a predetermined phase to at least a part of the M channel waveguides by a form of the at least the part of the M channel waveguides being changed.

2. The arrayed waveguide grating according to claim 1, wherein the phase correcting portion is configured to provide a phase of a(m−M/2)²+b(m−M/2)+c to the m^{th} channel waveguide of the M channel waveguides, wherein a, b, and c are constants of values within a range of −2Π to 2Π in radians.

3. The arrayed waveguide grating according to claim 1, wherein the phase correcting portion is configured to provide a phase of a(m−M/2)³+b(m−M/2)²+c(m−M/2)+d to the m^{th} channel waveguide of the M channel waveguides, wherein a, b, c, and d are constants of values within a range of −2Π to 2Π in radians.

4. The arrayed waveguide grating according to claim 1, wherein
the phase correcting portion includes a wide waveguide having a width W2 larger than a basic waveguide width W1 in each of a part or all of the M channel waveguides, and
a length of the wide waveguide is different for each of the channel waveguides.

5. The arrayed waveguide grating according to claim 1, wherein the phase correcting portion is configured such that only a length of each channel waveguide is changed for a part or all of the M channel waveguides.

6. The arrayed waveguide grating according to claim 1, wherein the M channel waveguides include a linear waveguide portion and the phase correcting portion is provided in the linear waveguide portion.
